(19) United States
(12) Patent Application Publication
(10) Pub. No.: US 2023/0375219 A1
(43) Pub. Date: Nov. 23, 2023

(54) SYSTEM FOR COLLECTING WATER FROM HVAC UNITS

(71) Applicant: Tony Jay Holt II, Flower Mound, TX (US)

(72) Inventor: Tony Jay Holt II, Flower Mound, TX (US)

(21) Appl. No.: 18/320,672

(22) Filed: May 19, 2023

Related U.S. Application Data
(60) Provisional application No. 63/365,027, filed on May 20, 2022.

(51) Int. Cl. F24F 13/22

(52) U.S. Cl. CPC F24F 13/222

(57) ABSTRACT

A water capture system is provided for collecting unused water generated from HVAC units. Water collected from the HVAC system may be treated before it is routed to an additional use, such as being fed through irrigation systems to alleviate issues caused by dry soil due to drought and water usage restrictions. When proper filtration systems are incorporated into a system, the water can also be used as potable water for household usage, such as flushing toilets, washing clothes, dishwashing, etc. This makes the normally wasted water into a usable commodity that can be harvested and used efficiently to offset the overwhelming demand on municipalities water supply and offset the associated costs related to the maintenance of these ever-growing facilities. All the while, this provides individual home and building owners with cost savings without changing their everyday habits by turning a once-wasted byproduct into a usable resource.

### CROSS-REFERENCE TO RELATED APPLICATIONS

The present application claims priority to U.S. Provisional Patent Application No. 63/365,027, filed May 20, 2022, the entire contents of which are hereby incorporated by reference.

### FIELD OF INVENTION

The present invention relates generally to a system for water collection. More specifically, the invention relates to a method for collecting condensation from heating, ventilation, and air conditioning (HVAC) units to store as usable water.

### BACKGROUND OF INVENTION

Many buildings have heating, ventilation, and air conditioning (HVAC) units which provide improved air quality and temperature regulation. HVAC units can also regulate moisture by pulling the humidity out of the air. This capture of humidity can create condensation in and on the HVAC units. In current systems, this condensation is not collected or stored, but rather it is sent directly to the sewer and is wasted. Water waste is a substantial problem in communities that are subject to drought conditions or lack of substantial natural water sources.

Droughts are known to cause various issues. From individuals lacking access to water to increased prices for water due to supply and demand issues to shifting of building foundations, the issues are expansive. Drought-ridden areas with sandy soils experience issues with contracting soil and sinking foundations. Not only can this lead to frustrating things such as doors sticking in doorways, but it can also lead to more serious issues. For example, dry foundations can cause walls to crack and pipes to break. If left untreated, homes can experience severe structural damage resulting in massive repair costs.

To address issues related to shifting foundations, individuals are suggested to “water” their foundations. Maintaining the soil moisture content surrounding a foundation can lift the foundation up to improve the sinkage. However, the current systems in place rely on regular irrigation systems focused on watering the lawn, which further strains the municipal water supply. Additionally, current systems do not utilize any of the water wasted as condensation created by the normal operation of an HVAC system.

### SUMMARY OF INVENTION

The present invention overcomes many of the shortcomings and limitations of the prior art devices discussed above. The invention described herein includes a method for collecting water from HVAC units. HVAC units produce condensation, which is underutilized and sent to the sewer. Using this water can provide many advantages. The water collection can be used to increase access to water, which ultimately drives the cost of water down. In this example, the water can be used for foundation moisture management. The collected water can be fed through a zone-controlled drip irrigation system to alleviate issues caused by drought conditions and dry soil. When proper filtration systems are incorporated, this harvested moisture can also be stored and used as potable water. This can serve as a means to offset the costs associated with the expansion of municipal water infrastructure due to population growth and offset the impact on water reservoirs due to the increase in demand and changing climate conditions.

### BRIEF DESCRIPTION OF DRAWINGS

FIG. 1 is a schematic view of a water collection system constructed according to the teachings of the present application.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

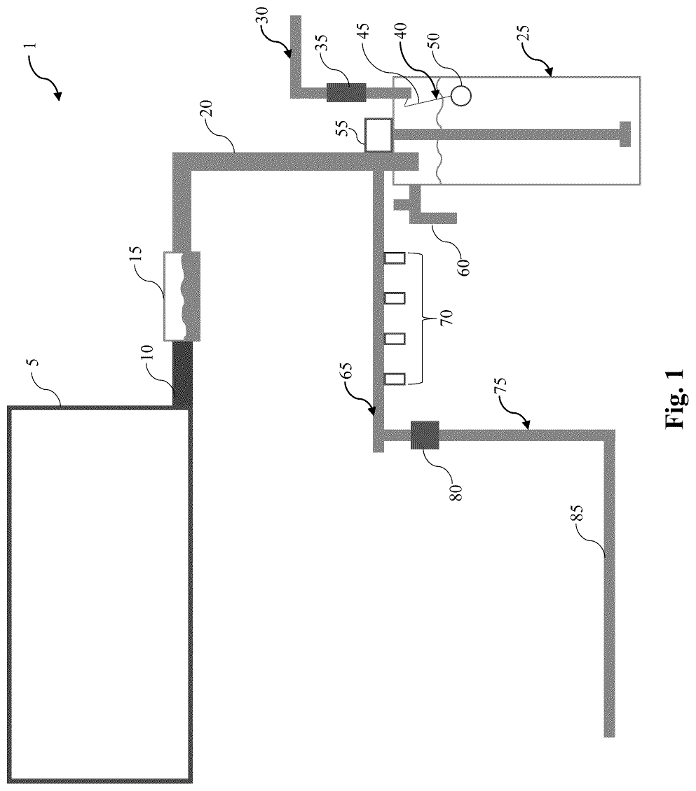

FIG. 1 illustrates a water collection system 1. The water collection system 1 is preferably attached to or otherwise in communication with a building automation system (not illustrated). In one embodiment, the water collection system 1 includes a heating, ventilation, and air conditioning (HVAC) unit 5 which may be located, for example, in an attic, basement, or exterior of a building. The HVAC unit 5 is preferably attached to an HVAC condensation line 10. The HVAC condensation line 10 transports the condensation produced by the HVAC unit 5.

The condensation collected into the HVAC condensation line 10 is preferably connected to an in-line potential hydrogen (pH) neutralizer 15. As illustrated, condensation is flowing through the pH neutralizer 15. In one embodiment, the condensation is neutralized. Neutralization is required as the condensation produced has a low-pH value. The low-pH condensation (or acidic condensation) can damage pipes, drainage system components, and subsequent plant life. Additionally, government entities can record a violation for those who allow this acidic wastewater to run to government-owned pipes. The pH neutralizer 15 raises the pH value of the condensation, which in turn lowers its acidic properties. The pH neutralizer 15 can be any condensate neutralizer known in the art.

After the condensation has been neutralized with the pH neutralizer 15, the condensation preferably passes through a first water line 20 and flows into the water storage tank 25. Additionally, in one embodiment, a supplemental water supply 30 is piped into the water storage tank 25. In one embodiment, the supplemental water supply 30 is provided by the city or county. The supplemental water supply 30 is preferably connected to a backflow preventer 35 to prevent possible contamination into the supplemental water supply piping (not illustrated). In one embodiment, the supplemental water supply 30 is only providing water during extended periods of time when the HVAC unit 5 is not operational due to mild temperatures, scheduled run times, or maintenance-related down times. The backflow preventer 35 is preferably connected to a ball float valve 40 in the water storage tank 25. The ball float valve 40 can be any ball float valve known in the art. In one embodiment, the ball float valve 40 comprises an arm 45 attached to a ball float 50. When the water (or any fluid in a storage tank) level rises, the arm 45 pivots and the ball float 50 stays atop the water. As the arm 45 pivots, a valve connected to the backflow preventer 35 closes. Once the arm 45 reaches a certain point, the valve connected to the backflow preventer 35 is fully closed. In one embodiment, the ball float 50 is completed submerged when condensation is flowing normally; the ball float 50 is only “in use” when necessary to maintain acceptable operation water level. When the valve connected to the backflow preventer 35 is fully closed, the water is prevented from continuing to fill the water storage tank 25.

The water storage tank 25 is preferably connected to a water pump 55, which extends into the water storage tank 25. In one embodiment, the water pump 55 is pressure activated, which is pressurized between sixty and ninety (60-90) pound-force per square inch (PSI). In one embodiment, the water pump 55 is powered by a 12 volt direct current (DC) system with battery back-up. In one embodiment, the water storage tank 25 is preferably connected to an overflow drainage line 60. This overflow drainage line 60 has a relief opening, which will release water in the case of an overflow. For example, if the water level exceeds a predefined threshold, the overflow drainage line 60 passively releases water from the water storage tank 25, bypasses the low flow zone control valve 80, and directly enters into the foundation drip irrigation line 85 for subsequent release into the soil surrounding the foundation.

The water storage tank 25 may be connected to a second water line 65. In one embodiment, the second water line 65 has future connections 70 included. FIG. 1 illustrates four future connections 70, but there may be more or less than four in embodiments. These future connections 70 are included to provide connections that supply water from the water collection system 1. In embodiments, these future connections 70 can supply water for flushing toilets, washing clothes, washing dishes, lawn irrigation systems, etc.

In one embodiment, the second water line 65 is preferably connected to a low flow zone control valve 80. The low flow zone control valve 80 can be any irrigation control valve known in the art. The low flow control valve 80 can be operated by or terminated to any automated irrigation control system known in the art and existing at the location of installation. The low flow control valve 80 can be utilize the scheduling and/or moisture level sensing technology, if available, to automate the activation of the low flow control valve 80 and subsequent release of water to the foundation drip irrigation line 85. The third water line 75 is preferably attached to a low flow zone control valve 80. In one embodiment, the low flow zone control valve 80 is attached to an existing home irrigation system. The third water line 75 is preferably connected to the foundation drip irrigation line 85, which in one embodiment, provides water to the foundation.

In alternative embodiments, the third water line 75 may supply water to other applications in geographic areas where soil and weather conditions are more stable and structures are less susceptible to foundation issues.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A method for collecting water comprising:
collecting condensation from a heating, ventilation, and air conditioning unit, wherein the condensation has a first potential hydrogen (pH) level;
neutralizing the condensation to a second pH level; and
supplying the condensation with the second pH level to a storage tank for use.

2. The method of claim 1, further comprising the step of providing the condensation with the second pH level to an output water line.

3. The method of claim 2, wherein the output water line is an irrigation line configured to water a building foundation.

4. The method of claim 1, wherein the second pH level is higher than the first pH level.

5. The method of claim 1, wherein the storage tank is connected to a water pump, and wherein the water pump is pressure activated.

6. The method of claim 1, further comprising the step of providing a supplemental water supply to the storage tank.

7. The method of claim 6, wherein the supplemental water supply is connected to a backflow preventer, and wherein the backflow preventer is configured to prevent contamination of water supplied by the supplemental water supply.

8. The method of claim 1, wherein the condensation is neutralized by a pH neutralizer.

9. A water collection system comprising:
a heating, ventilation, and air conditioning (HVAC) unit;
a condensation line attached to the HVAC unit;
a potential hydrogen (pH) neutralizer configured to neutralize condensation produced by the HVAC unit; and
a storage tank configured to contain the condensation neutralized by the pH neutralizer.

10. The water collection system of claim 9, wherein the water collection system is in connection with a building automation system.

11. The water collection system of claim 9, further comprising an output water line in fluid communication with the storage tank.

12. The water collection system of claim 11, wherein the output water line is in fluid communication with at least one of an irrigation system, a toilet, a washing machine, and a dishwasher.

13. The water collection system of claim 9, wherein the pH neutralizer is configured to raise a pH level of the condensation produced by the HVAC unit.

14. The water collection system of claim 9, further comprising a supplemental water supply for delivering additional water to the storage tank.

15. The water collection system of claim 9, further comprising a water pump configured to pump the condensation neutralized by the pH neutralizer from the storage tank.

16. The water collection system of claim 14, wherein the supplemental water supply is connected to a backflow preventer.

17. A method for collecting water comprising:
collecting condensation from a heating, ventilation, and air conditioning unit, wherein the condensation has a first potential hydrogen (pH) level;
neutralizing the condensation to a second pH level; and
supplying the condensation with the second pH level to an output water line.

18. The method of claim 17, wherein the second pH level is higher than the first pH level.

19. The method of claim 17, further comprising the step of supplying the condensation with the second pH level to a storage tank for use.

20. The method of claim 17, wherein the output water line is an irrigation line configured to water a building foundation.
